(19) United States
(12) Patent Application Publication
(10) Pub. No.: US 2006/0129394 A1
(43) Pub. Date: Jun. 15, 2006

(54) Method for communicating using synthesized speech

(75) Inventors: Craig Henry Becker, Austin, TX (US); Leugim A. Bustelo, Austin, TX (US)

Correspondence Address: IBM CORPORATION (SWP);C/O SUITER WEST SWANTZ PC LLO, 14301 FNB PARKWAY, SUITE 220, OMAHA, NE, 68154-5299, US

(73) Assignee: INTERNATIONAL BUSINESS MACHINES CORPORATION, ARMONK, NY (US)

(21) Appl. No.: 11/008,794

(22) Filed: Dec. 9, 2004

(51) Int. Cl. G10L 15/26

(52) U.S. Cl. 704/235

(57) ABSTRACT

The present invention is a method for communicating using synthesized speech including the steps of: capturing subvocal speech signals from a first party; applying subvocal speech recognition to the signals to generate speech text; and, transmitting the generated speech text to a second party.

### FIELD OF THE INVENTION

The present invention relates to the field of communication and particularly to a system and method for communicating using synthesized speech.

### BACKGROUND OF THE INVENTION

The ability to communicate accurately and privately is important. In noisy environments, the ability to communicate either accurately or privately may be hindered. For example, a first party, such as an air traffic controller located in an airport tower, may be attempting to communicate with a second party, such as a pilot flying an airplane. However, because airport towers are sometimes noisy environments, the pilot may not be able to accurately hear the air traffic controller's directions. If the air traffic controller is forced to raise his or her voice so that the pilot can accurately hear the directions, other air traffic controllers located in the airport tower may be distracted.

Therefore, it would be advantageous to have a system and method for communicating using synthesized speech, which allows two or more parties to communicate in an accurate and private manner.

### SUMMARY OF THE INVENTION

Accordingly, the present invention is directed to a method for communicating using synthesized speech including the steps of: capturing subvocal speech signals from a first party; applying subvocal speech recognition to the signals to generate speech text; and, transmitting the generated speech text to a second party.

An additional embodiment of the present invention is directed to a method for communicating using synthesized speech including the steps of: receiving speech text generated from subvocal speech signals, the speech text being transmitted from a first location; synthesizing audible speech from the speech text; and, outputting the synthesized audible speech at a second location.

A further embodiment of the present invention is directed to a system for communicating using synthesized speech including: a first computing device at a first location; and, a second computing device at a second location; wherein each computing device is configured with a plurality of sensors, a subvocal speech recognition program, a speech synthesizing program and an audio output device; wherein the computing devices transmit and receive speech text in a bi-directional manner; wherein the first and second computing devices communicate via wireless transmission.

An additional embodiment of the present invention is directed to a method for communicating using synthesized speech including the steps of: capturing subvocal speech signals from a first party; applying subvocal speech recognition to the signals to generate speech text; synthesizing audible speech from the speech text; and, transmitting the synthesized audible speech to a second computing device.

A further embodiment of the present invention is directed to a method for communicating using synthesized speech including the steps of: receiving synthesized audible speech generated from subvocal speech signals, the synthesized audible speech being transmitted from a first location; and, outputting the synthesized audible speech.

An additional embodiment of the present invention is directed to a method for communicating using synthesized speech including the steps of: capturing subvocal speech signals from a first party; and, transmitting the speech signals to a second party.

A further embodiment of the present invention is directed to a method for communicating using synthesized speech including the steps of: receiving subvocal speech signals, the subvocal speech signals being transmitted from a first location; applying subvocal speech recognition to the signals to generate speech text; synthesizing audible speech from the speech text; and, outputting the synthesized audible speech.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flowchart illustrating a method for communicating using synthesized speech in accordance with an exemplary embodiment of the present invention;

FIG. 2 is a flowchart illustrating a method for communicating using synthesized speech in accordance with an exemplary embodiment of the present invention;

FIG. 3 illustrates a system for communicating using synthesized speech in accordance with an exemplary embodiment of the present invention;

FIG. 4 is a flowchart illustrating a method for communicating using synthesized speech in accordance with an exemplary embodiment of the present invention;

FIG. 5 is a flowchart illustrating a method for communicating using synthesized speech in accordance with an exemplary embodiment of the present invention;

FIG. 6 is a flowchart illustrating a method for communicating using synthesized speech in accordance with an exemplary embodiment of the present invention;

FIG. 7 is a flowchart illustrating a method for communicating using synthesized speech in accordance with an exemplary embodiment of the present invention; and,

FIG. 8 illustrates the implementation of the sensors in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

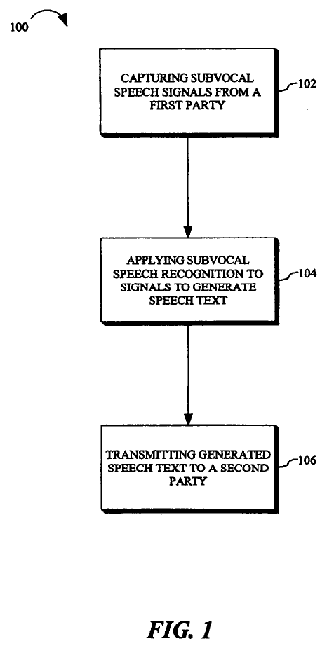

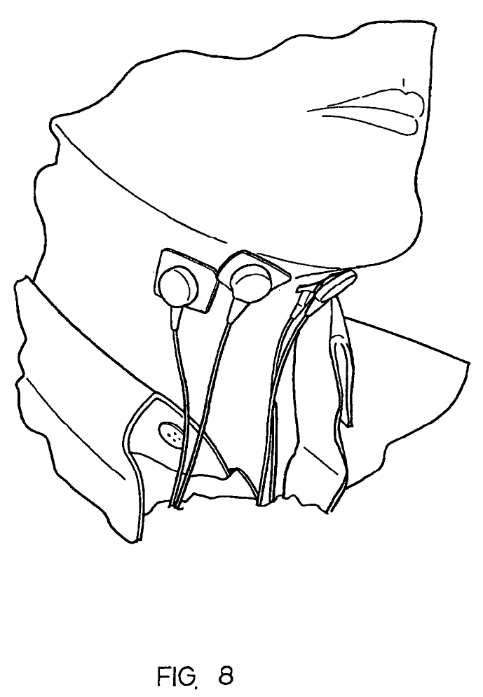

Referring generally to FIG. 1, a method for communicating using synthesized speech in accordance with an embodiment of the present invention is discussed. The method 100 includes capturing subvocal speech signals from a first party 102. In a present embodiment, a first computing device, such as a personal computer, a cell phone or the like, captures subvocal speech signals 102 from a first party via one or more sensors implemented with the first computing device. In an exemplary embodiment, the one or more sensors receive electrical nerve signals from and are in physical contact with an area proximal to the throat of the first party. (FIG. 8). Upon the first party silently talking to himself, subvocal speech signals (i.e.—electrical nerve signals) are generated which are captured by the sensors 102.

The method 100 further includes applying subvocal speech recognition to the signals to generate speech text 104. In a present embodiment, the first computing device applies subvocal speech recognition to the signals 104 via a program implemented with the first computing device, such as a software program, firmware program or the like. In an exemplary embodiment, each signal has a unique signal pattern, such as an electromyelogram/electropalatogram (EMG/EPG) reading. The program first reads the signals to determine each signal's pattern. The program then compares each signal's pattern to a stored database of known signal pattern-word and/or signal pattern-sound pairings to determine the words/sounds (i.e.—speech text) associated with the signals. The program then causes the first computing device to generate speech text associated with the signals. In further embodiments, upon being captured by the first computing device 102, and prior to the application of subvocal speech recognition 104, the subvocal speech signals are amplified by an amplification device implemented with the first computing device. In additional embodiments, the subvocal speech signals are processed to remove signal noise upon being captured by the first computing device 102, and prior to the application of subvocal speech recognition 104.

The method 100 further includes transmitting the generated speech text to a second party 106. In a present embodiment, the first computing device transmits the generated speech text to a second party via a wireless transmitter. For example, the wireless transmitter is a cell phone, a Bluetooth transmitter, an 802.11 transmitter or the like.

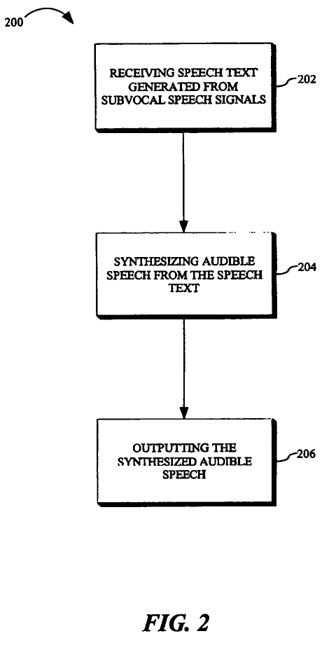

Referring generally to FIG. 2, a method for communicating using synthesized speech in accordance with an embodiment of the present invention is discussed. The method 200 includes receiving speech text generated from subvocal speech signals, the speech text being transmitted from a first location 202. In a present embodiment, the speech text is wirelessly transmitted from a first location and wirelessly received by a second computing device located at a second location. For example, the second computing device is a personal computer, a cell phone, or the like.

The method 200 further includes synthesizing audible speech from the speech text 204. In a present embodiment, a program, such as a text-to-speech software program, firmware program or the like, implemented within the second computing device synthesizes audible speech from the transmitted speech text.

The method 200 further includes outputting the synthesized audible speech 206. In a present embodiment, the second computing device outputs the synthesized audible speech at the second location via an audio output device implemented with the second computing device, such as a speaker, an ear piece or the like.

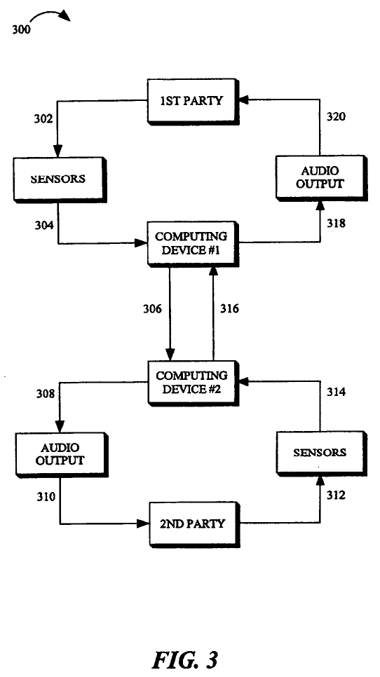

Referring generally to FIG. 3, a system 300 for communicating using synthesized speech includes: a first computing device at a first location; and, a second computing device at a second location; wherein each computing device is configured with a plurality of sensors, a subvocal speech recognition program, a speech synthesizing program and an audio output device; wherein the computing devices transmit and receive speech text in a bi-directional manner; wherein the first and second computing devices communicate via wireless transmission. In a present embodiment, a first party transfers subvocal speech signals to one or more sensors, the sensors being in physical contact with the first party in an area proximal to the first party's throat 302. The subvocal speech signals are then captured by a first computing device via the sensors 304. The first computing device then applies subvocal speech recognition to the captured signals to generate speech text. In an exemplary embodiment, subvocal speech recognition is applied via a software program (i.e.—a subvocal speech recognition program) implemented with the first computing device. Upon generating speech text from the captured subvocal speech signals, the first computing device transmits the generated speech text, and the generated speech text is received by a second computing device 306. In a present embodiment, the generated speech text is transmitted and received wirelessly. Upon receiving the transmitted speech text 306, the second computing device synthesizes audible speech from the speech text via a software program (i.e.—a speech synthesizing program) implemented with the second computing device. Upon synthesizing audible speech from the speech text, the second computing device sends the synthesized audible speech to an audio output device implemented with the second computing device 308. The audio output device then outputs the synthesized audible speech to a second party 310. Steps 312-320 mirror steps 302-310, except that the direction of communication is from the second party to the first party.

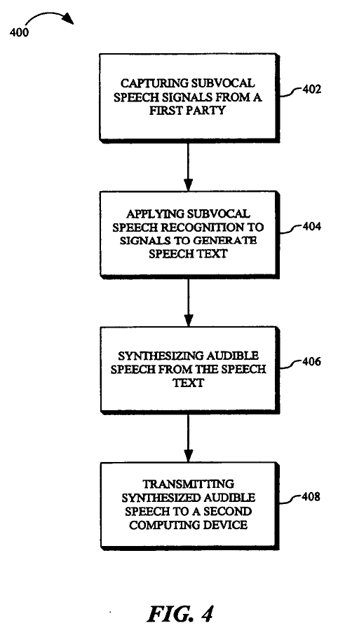

Referring generally to FIG. 4, a method for communicating using synthesized speech in accordance with an embodiment of the present invention is discussed. The method 400 includes capturing subvocal speech signals from a first party 402. In a present embodiment, a first computing device, such as a personal computer, a cell phone or the like, captures subvocal speech signals 402 from a first party via one or more sensors implemented with the first computing device.

The method 400 further includes applying subvocal speech recognition to the signals to generate speech text 404. In a present embodiment, the first computing device applies subvocal speech recognition to the signals 404 via a program implemented with the first computing device, such as a software program, firmware program or the like.

The method 400 further includes synthesizing audible speech from the speech text 406. In a present embodiment, a program, such as a text-to-speech software program, firmware program or the like, implemented within the first computing device synthesizes audible speech from the speech text.

The method 400 further includes transmitting the synthesized audible speech to a second computing device 408. In a present embodiment, the first computing device transmits the synthesized audible speech, for example, analog voice data, to a second computing device at a second location via a wireless transmitter. For example, the wireless transmitter is a cell phone, a Bluetooth transmitter, an 802.11 transmitter or the like.

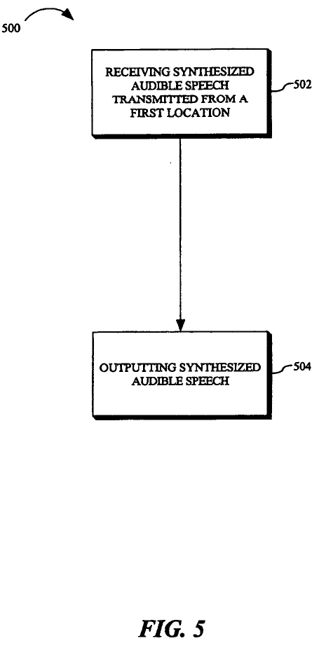

Referring generally to FIG. 5, a method for communicating using synthesized speech in accordance with an embodiment of the present invention is discussed. The method 500 includes receiving synthesized audible speech generated from subvocal speech signals 502, the synthesized audible speech being transmitted from a first location 408. (FIG. 4) In a present embodiment, the audible speech (i.e.—analog voice data) is wirelessly transmitted from a first location and wirelessly received by a second computing device located at a second location. For example, the second computing device is a personal computer, a cell phone, or the like.

The method 500 further includes outputting the synthesized audible speech 504. In a present embodiment, the second computing device outputs the synthesized audible speech at the second location via an audio output device implemented with the second computing device, such as a speaker, an ear piece or the like.

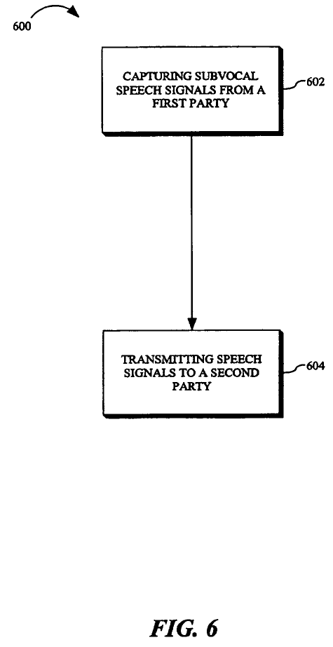

Referring generally to FIG. 6, a method for communicating using synthesized speech in accordance with an embodiment of the present invention is discussed. The method 600 includes capturing subvocal speech signals from a first party 602. In a present embodiment, a first computing device, such as a personal computer, a cell phone or the like, captures subvocal speech signals 602 from a first party via one or more sensors implemented with the first computing device.

The method 600 further includes transmitting the speech signals to a second party 604. In a present embodiment, the first computing device transmits the speech signals to a second party via a wireless transmitter. For example, the wireless transmitter is a cell phone, a Bluetooth transmitter, an 802.11 transmitter or the like.

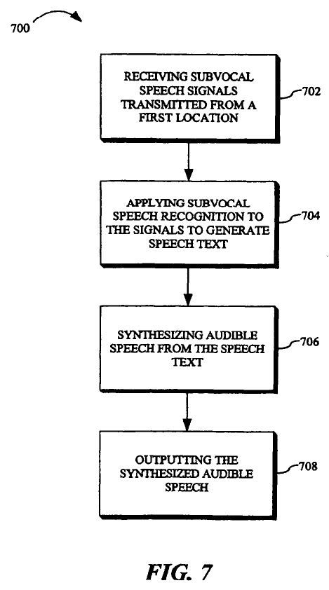

Referring generally to FIG. 7, a method for communicating using synthesized speech in accordance with an embodiment of the present invention is discussed. The method 700 includes receiving subvocal speech signals 702, the subvocal speech signals being transmitted from a first location 604. (FIG. 6) In a present embodiment, the speech signals are wirelessly transmitted from a first location and wirelessly received by a second computing device located at a second location. For example, the second computing device is a personal computer, a cell phone, or the like.

The method 700 further includes applying subvocal speech recognition to the signals to generate speech text 704. In a present embodiment, the second computing device applies subvocal speech recognition to the signals 704 via a program implemented with the second computing device, such as a software program, firmware program or the like.

The method 700 further includes synthesizing audible speech from the speech text 706. In a present embodiment, a program, such as a text-to-speech software program, firmware program or the like, implemented within the second computing device synthesizes audible speech from the speech text.

The method 700 further includes outputting the synthesized audible speech 708. In a present embodiment, the second computing device outputs the synthesized audible speech at the second location via an audio output device implemented with the second computing device, such as a speaker, an ear piece or the like.

Further, it is contemplated that the methods and system for communicating using synthesized speech as described above may be adapted to allow for multiple (i.e.—three or more) parties to communicate in a multi-directional manner.

It is believed that the method of the present invention and many of its attendant advantages will be understood by the forgoing description. It is also believed that it will be apparent that various changes may be made in the form, construction and arrangement of the steps thereof without departing from the scope and spirit of the invention or without sacrificing all of its material advantages. The form herein before described being merely an explanatory embodiment thereof.

What is claimed is:

1. A method for communicating using synthesized speech, comprising:
capturing subvocal speech signals from a first party;
applying subvocal speech recognition to the signals to generate speech text; and,
transmitting the generated speech text to a second party.

2. A method as claimed in claim 1, wherein applying subvocal speech recognition to the captured signals includes reading the signals, comparing the signals to a stored database of signal-word pairings and generating speech text.

3. A method as claimed in claim 1, wherein, upon being captured, the subvocal speech signals are amplified.

4. A method as claimed in claim 1, wherein, upon being captured, the subvocal speech signals are processed to remove signal noise.

5. A method as claimed in claim 1, wherein the generated speech text is transmitted wirelessly.

6. A method for communicating using synthesized speech, comprising:
receiving speech text generated from subvocal speech signals, the speech text being transmitted from a first location;
synthesizing audible speech from the speech text; and,
outputting the synthesized audible speech at a second location.

7. A method as claimed in claim 6 wherein the transmitted speech text is wirelessly received at the second location.

8. A method as claimed in claim 6 wherein audible speech is synthesized from the transmitted speech text.

9. A method as claimed in claim 6 wherein the synthesized audible speech is output at the second location.

10. A system for communicating using synthesized speech, comprising:
a first computing device at a first location; and,
a second computing device at a second location;
wherein each computing device is configured with a plurality of sensors, a subvocal speech recognition program, a speech synthesizing program and an audio output device;
wherein the computing devices transmit and receive speech text in a bi-directional manner;
wherein the first and second computing devices communicate via wireless transmission.

11. A system as claimed in claim 10, wherein the sensors capture subvocal speech signals.

12. A system as claimed in claim 11, wherein each subvocal speech recognition program generates speech text from the captured subvocal speech signals.

13. A system as claimed in claim 10, wherein each speech synthesizing program generates audible speech from transmitted speech text.

14. A system as claimed in claim 10, wherein each audio output device outputs synthesized audible speech.
